(19) United States
(12) Patent Application Publication
(10) Pub. No.: US 2025/0033745 A1
(43) Pub. Date: Jan. 30, 2025

(54) TENSION-LEG FLOATING OFFSHORE PLATFORM AND INSTALLATION METHOD THEREOF

(71) Applicant: BITMAIN TECHNOLOGIES INC., Beijing (CN)

(72) Inventors: Tuo GENG, Beijing (CN); Qiwei BAI, Beijing (CN); Minghao LI, Beijing (CN); Shuangquan HUA, Beijing (CN); Fengjie LI, Beijing (CN); Guo WU, Beijing (CN)

(21) Appl. No.: 18/783,151

(22) Filed: Jul. 24, 2024

(30) Foreign Application Priority Data
Jul. 24, 2023 (CN) 202310912859.9

(51) Int. Cl. B63B 35/44; B63B 21/50

(52) U.S. Cl. CPC B63B 35/44; B63B 21/502; B63B 2207/02

(57) ABSTRACT

The present disclosure provides a tension-leg floating offshore platform, including a floating body assembly and a detachable temporary floating body; where, during a process of the floating body assembly being towed to an operating sea area, the temporary floating body is movably installed on the floating body assembly; after the floating body assembly is moored to the operating sea area, the temporary floating body is separated from the floating body assembly. The tension-leg floating offshore platform provided in the present disclosure enables the tension-leg floating offshore platform to maintain stability during its installation process.

### CROSS-REFERENCE TO RELATED APPLICATION

The present disclosure claims priority to Chinese Patent Application No. 202310912859.9, filed on Jul. 24, 2023, which is hereby incorporated by reference in its entirety.

### TECHNICAL FIELD

The present disclosure relates to, but is not limited to, the field of offshore platforms, and in particular, to a tension-leg floating offshore platform and its installation method.

### BACKGROUND

There are mainly three basic forms of floating offshore platforms, namely spar, semi-submersible and tension leg platform. The difference mainly lies in how to resist the overturning moment of the wind turbine during power generation and installation. Where, the spar-type platform refers to lowering the center of gravity of the floating body, where the waterline area of the floating body is relatively small, but the structural moulded-depth of the floating body is extremely large, making it suitable for deeper sea areas. The semi-submersible platform may make the restoring moment of the floating body balance the overturning moment by larger waterline area, moment of inertia, and floating body displacement. The semi-submersible offshore platform also includes a main body of the wind turbine, which has extremely high requirements for inclination angle. The buoyancy of the tension-leg offshore platform is much greater than its gravity. The tension tendon is always in a tensioned state, and the overturning moment of the wind turbine is balanced by the force moment of the tension tendon. The displacement of the floating body may be set very small. The floating body itself uses less steel, but the tension tendon is a steel tube structure, which usually requires deep water to be suitable. The mooring system of traditional tension-leg offshore platform is difficult to install.

### SUMMARY

The present disclosure provides a tension-leg floating offshore platform and an installation method thereof, so that the tension-leg floating offshore platform can maintain its stability during the installation process.

In a first aspect, the present disclosure provides a tension-leg floating offshore platform, including: a floating body assembly and a detachable temporary floating body; where, during a process of the floating body assembly being towed to an operating sea area, the temporary floating body is movably installed on the floating body assembly; after the floating body assembly is moored to the operating sea area, the temporary floating body is separated from the floating body assembly.

In some possible implementations, the tension-leg floating offshore platform further includes: a ballast water system fixedly connected to the floating body assembly; when the floating body assembly is towed to the operating sea area and is not moored, the ballast water system increases the load of the floating body assembly; when the floating body assembly is moored to the operating sea area, the ballast water system gradually adjusts the load of the floating body assembly according to a preset increment.

In some possible implementations, during a process of the ballast water system increasing the load of the floating body assembly to a first preset value, the temporary floating body remains movably installed on the floating body assembly; after the ballast water system decreasing the load of the floating body assembly to a second preset value, the temporary floating body is separated from the floating body assembly.

In some possible implementations, the tension-leg floating offshore platform further includes: a mooring assembly arranged on the floating body assembly, the the mooring assembly being capable of being connected to an anchor sunk at a bottom of the sea so as to moor the floating body assembly to the operating sea area after the floating body assembly is towed to the operating sea area.

In some possible implementations, when the floating body assembly is moored to the operating sea area, at least one portion of the floating body assembly is located on a sea surface of the operating sea area, and the mooring assembly is arranged on the at least one portion.

In some possible implementations, the floating body assembly includes: a fixed floating body, a crossbeam and a plurality of side columns; the fixed floating body and the crossbeam are arranged in parallel, and the plurality of side columns are vertically arranged between the fixed floating body and the crossbeam so as to connect the fixed floating body and the crossbeam; each side column is in a hollow structure; and the fixed floating body and the plurality of side columns are configured for providing buoyancy for the crossbeam.

In some possible implementations, the temporary floating body is sleeved on the side column, and the temporary floating body is able to move relative to the side column.

In some possible implementations, the crossbeam is connected to the plurality of side columns, an end of the crossbeam is exposed to an outer wall of the side column, and the end of the crossbeam is configured to install the mooring assembly.

In a second aspect, the present disclosure provides an installation method for a tension-leg floating offshore platform, for installing the tension-leg floating offshore platform as described in the above embodiments, including: movably installing a temporary floating body on a floating body assembly; and separating the temporary floating body from the floating body assembly after the floating body assembly is moored to the operating sea area.

In some possible implementations, before the floating body assembly being moored to the operating sea area, the above method further includes: controlling a ballast water system to increase the load of the floating body assembly to a first preset value after the floating body assembly is towed to an operating sea area; mounting an anchor on the floating body assembly via a mooring rope to moor the floating body assembly; controlling the ballast water system to gradually decrease the load of the floating body assembly according to a preset increment; separating the temporary floating body from the floating body assembly after the load of the floating body assembly is decreased to a second preset value.

In the present disclosure, the tension-leg floating offshore platform includes a floating body assembly and a detachable temporary floating body. The detachable temporary floating body is not rigidly connected to the floating body assembly and may float up and down relative to the floating body assembly, making it easy to disassemble and install, and may be reused to reduce the cost of use. The temporary floating body may provide stability during the installation process of the tension-leg floating offshore platform and prevent the tension-leg floating offshore platform from overturning.

It should be understood that the foregoing general description and the following detailed description are only exemplary and explanatory, and do not limit the present disclosure.

### BRIEF DESCRIPTION OF DRAWINGS

The drawings here, which are incorporated in and constitute a part of the present specification, illustrate embodiments in accordance with the present disclosure and together with the description, serve to explain the principles of the present disclosure.

FIG. 1 shows a steel pontoon structure in a form of three-column.

FIG. 2 is a perspective view of a tension-leg floating offshore platform in an embodiment of the present disclosure.

FIG. 3 is a top view of a temporary floating body in an embodiment of the present disclosure.

FIG. 4 is a side view of a temporary floating body in an embodiment of the present disclosure.

FIG. 5 is another perspective view of a tension-leg floating offshore platform in an embodiment of the present disclosure.

FIG. 6 is a schematic flow chart of an installation method for a tension-leg floating offshore platform in an embodiment of the present disclosure.

### DESCRIPTION OF REFERENCE SIGNS

11—steel cylinder; 12—connecting column; 20—tension-leg floating offshore platform; 21—floating body assembly; 211—side column; 212—crossbeam; 213—fixed floating body; 22—temporary floating body; 221—airbag; 222—frame structure; 223—ballast structure; 23—wind turbine main body; 61—mooring rope; 62—mooring assembly.

### DESCRIPTION OF EMBODIMENTS

Exemplary embodiments will be described in detail herein, examples of which are illustrated in the drawings. When the following description involves the drawings, unless otherwise indicated, the same numbers in different drawings refer to the same or similar elements. The implementations described in the following exemplary embodiments do not represent all implementations consistent with the present disclosure. On the contrary, they are merely examples of devices consistent with some aspects of the present disclosure as detailed in the appended claims.

Other implementation solutions of the present disclosure will be readily apparent to those skilled in the art from consideration of the specification and practice of the disclosure claimed herein. The present disclosure is intended to cover any variations, uses, or adaptive changes of the present disclosure that follow the general principles of the present disclosure and include common knowledge or customary technical means in the technical field that are not yet disclosed in the present disclosure. The specification and embodiments are only considered exemplary, with a true scope and spirit of the present disclosure being indicated by the claims.

In order to illustrate the technical solutions of the present disclosure, specific embodiments are provided below.

There are abundant wind resources at sea, and the wind speed at sea is more stable and has little impact on the environment. Worldwide, major economic entities are paying more and more attention to the development of offshore wind power generation. At present, in intertidal zones, tidal flats and coastal waters where the water depth does not exceed 50 m, offshore wind power usually uses fixed foundations, such as single pile, jacket, high pile bearing platform and other foundation forms. The deep sea has more abundant wind resources. According to statistics, in China, the offshore wind energy reserves at a height of 70 m is about 500 million kilowatts within a water depth of 5 m to 50 m, while the wind energy reserves in deep water areas above 50 m water depth is about 1.3 billion kilowatts, accounting for more than 60%, which is much higher than shallow water areas.

As for offshore platform of wind power generation, there are generally two types: fixed and floating. Offshore platform may be fixed or floating on the sea surface, and may provide an offshore operating platform for production operations or other activities. At present, it has been widely used for providing fixed observation platform for the construction of lighthouse, radar station, hydrological and meteorological station, etc., as well as for providing large-scale operating platform for construction of offshore terminal, drilling and mining submarine oil and oil gas exploitation, fisheries fishing, energy generation, etc. Where, traditional fixed offshore platform faces huge challenges in technology and economy, and their requirements for construction equipment are getting higher and higher. The floating offshore platform is connected to the seabed through a mooring system, which is less affected by water depth and avoids problems such as piling construction in complex geological sea areas. Therefore, research on offshore floating foundation wind power has attracted more and more attention.

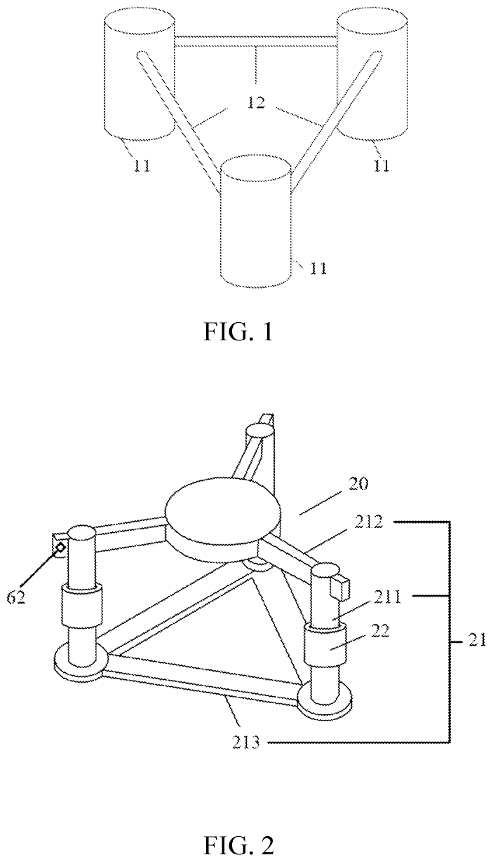

The main structure that enables a floating offshore platform to float on the sea surface is a floating structure having buoyancy, which is usually a buoyant pontoon. One of the floating offshore structures is mostly a three-column or four-column steel pontoon structure, which is mainly formed by a combination of several steel hollow cylinders. FIG. 1 shows a steel pontoon structure in a form of three-column. As shown in FIG. 1, the pontoon structure includes three hollow steel cylinders 11 and connecting columns 12 for fixing the cylinders. One end of the cylinder sunk into the sea surface is provided with an opening. The interior of the steel cylinder 11 may be designed in a form of stiffened plate to provide buoyancy, stability and resistance to external water pressure for the floating body, or to withstand other internal and external loads.

There are mainly three basic forms of floating offshore platforms developed from the traditional oil and gas industry, namely spar (SPAR), semi-submersible (SEMI) and tension leg platform (TLP). The difference among them mainly lies in how to resist the overturning moment of the wind turbine during power generation and installation. The spar-type platform lies in lowering the center of gravity of the floating body; although the waterline area of the floating body is relatively small, the structural depth of the floating body is extremely large, which is suitable for deeper sea areas. The first offshore floating wind power plant—Hywind Project has an operating water depth of 95 m to 120 m; and the spar-type floating body is extremely difficult to tow and install. The semi-submersible platform may make the restoring moment of the floating body balance the overturning moment by larger waterline area, moment of inertia, and floating body displacement. The main body of the wind turbine in the semi-submersible wind power platform has extremely high requirements for inclination angle, usually requiring the inclination angle of the floating body not more than 10 degrees, and some even not more than 5 degrees, therefore, the requirement for the waterline area of the floating body is increased, the wave load is larger, and a large amount of ballast weight is more necessary, resulting in the displacement much greater than the weight that the floating body itself needs to bear, and a relatively large amount of steel is also used. For a tension-leg floating body, its buoyancy is much larger than its gravity; the tension tendon is always in a tensioned state, and the overturning moment of the wind turbine is balanced by the moment of force of the tension tendon; the displacement of the floating body may be set very small, and the floating body itself uses less steel, but the tension tendon is a steel tube structure, which usually requires deep water to be applicable. The mooring system of traditional tension-leg offshore platform is difficult to install.

In order to solve the above problems, an embodiment of the present disclosure provides a tension-leg floating offshore platform so that the tension-leg floating offshore platform can maintain stability during installation.

In an embodiment of the present disclosure, the above-mentioned tension-leg floating offshore platform may include: a floating body assembly and a detachable temporary floating body; where, during the process of the floating body assembly being towed to an operating sea area, the temporary floating body is movably installed on the floating body assembly; after the floating body assembly is moored to the operating sea area, the temporary floating body is separated from the floating body assembly.

Exemplarily, FIG. 2 is a perspective view of a tension-leg floating offshore platform in an embodiment of the present disclosure. As shown in FIG. 2, the tension-leg floating offshore platform 20 includes: a floating body assembly 21 and a detachable temporary floating body 22. Where, the floating body assembly 21 is composed of a side column 211, a crossbeam 212 and a fixed floating body 213; during the process of the floating body assembly 21 being towed to the operating sea area, the temporary floating body 22 is sleeved on the side column 211, and the temporary floating body 22 is not fixedly connected to the side column along a direction perpendicular to the sea surface, so that the temporary floating body 22 may move vertically on an outer wall of the side column 211 and rotate around the side column 211; after the floating body assembly 21 is moored to the operating sea area, the temporary floating body 22 is separated from the floating body assembly 21.

In an embodiment of the present disclosure, a cross section of the side column 211 may be circular or in other shapes, which is not specifically limited in the embodiments of the present disclosure. The interior of the side column 211 may be configured as a hollow structure, and the side column 211 together with the fixed floating body provides buoyancy for the tension-leg floating offshore platform 20. The crossbeam 212 may be any of the following: box-shaped crossbeam, T-shaped crossbeam, and circular crossbeam, which is not specifically limited in the embodiments of the present disclosure. The number of crossbeams 212 may be 3, and these 3 crossbeams 212 form a triangle; the number of crossbeams 212 may also be 4, and these 4 crossbeams 212 form a rectangle; the number of crossbeams 212 and the shape formed by the combination may be designed according to actual needs, which is not specifically limited in the embodiments of the present disclosure. When the tension-leg floating offshore platform 20 is located in seawater, the fixed floating body 213 is located below the sea surface. A height of the fixed floating body 213 from the sea surface may be designed according to the wavelength of the sea area, for example half a wavelength. A total buoyancy of the tension-leg floating offshore platform 20 is greater than 60% of a total weight of the tension-leg floating offshore platform 20.

In an embodiment of the present disclosure, the side column 211 may be configured as a hollow structure to provide buoyancy. The interior of the side column 211 is a reinforced concrete slab structure. The size of the side column 211 may be designed according to the buoyancy required by the tension-leg floating offshore platform 20, which is not limited in the embodiments of the present disclosure. The materials of the side column 211 may include but are not limited to: high-strength steels (such as AH32 and AH36). In addition to the above materials, the side column 211 may also be made of other materials that meet the strength requirements, which is not limited in the embodiments of the present disclosure.

In some possible implementations, the temporary floating body 22 may be composed of N airbags, where N is a positive integer greater than 1.

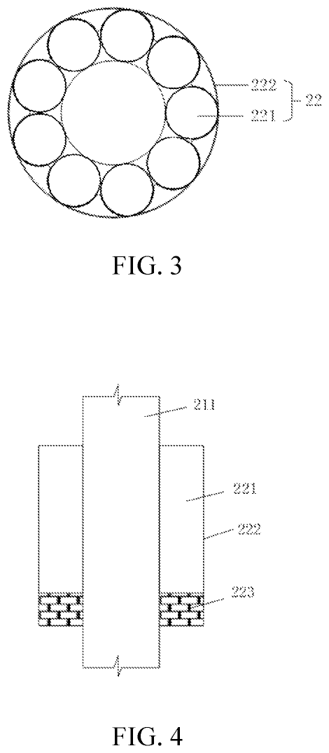

Exemplarily, FIG. 3 is a top view of a temporary floating body in an embodiment of the present disclosure. As shown in FIG. 3, the temporary floating body 22 includes 9 airbags 221 (i.e., N=9), and the airbags 221 are made of lightweight materials with a density smaller than that of seawater. When the temporary floating body 22 is located in seawater, the airbag 221 is used for providing buoyancy for the temporary floating body 22. At the same time, these 9 airbags 221 are fixed by the frame structure 222 to remain attached to the outer wall of the side column 211.

It should be noted that the temporary floating body 22 in FIG. 3 including 9 airbags 221 is only taken as an example. The airbags 221 in the temporary floating body 22 may also be in other quantities. The specific number and size of airbags 221 may be set according to actual needs, which is not limited in the embodiments of the present disclosure.

In an embodiment of the present disclosure, the frame structure 222 may be made of steel material or flexible material. Where, the steel material may include but is not limited to: copper, aluminum, titanium, etc.; the flexible material may include but is not limited to: binding strap, locking strap, latch strap, fishbone strap, etc. The material of the frame structure 222 is not specifically limited in the embodiments of the present disclosure.

In some possible implementations, the temporary floating body 22 may also include: a ballast structure for balancing the buoyancy and gravity of the temporary floating body 22, and the ballast structure is arranged at the bottom of the temporary floating body 22.

Exemplarily, FIG. 4 is a side view of a temporary floating body in an embodiment of the present disclosure. As shown in FIG. 4, in order to balance the buoyancy of the temporary floating body 22 and the weight of the temporary floating body 22 itself, a ballast structure 223 may be added to the temporary floating body 22, to lower the center of gravity of the temporary floating body 22. The ballast structure 223 is arranged at the bottom of the temporary floating body 22 and is fixedly connected to the airbag 221.

In an embodiment of the present disclosure, the ballast structure 223 may be formed by concrete pouring. The use of concrete pouring to produce the ballast structure 223 is not only low in manufacturing cost, but also the pouring shape may adapt to the shape of the airbag 221, so that the ballast structure 223 and the airbag 221 can be bent to fit with each other, which is equivalent to the ballast structure 223 and the airbag 221 being an integrated structure with no gap therebetween. There will be no inconsistency in the buoyancy force due to changes in the water surface line, improving the stability of the temporary floating body 22.

In some possible implementations, the tension-leg floating offshore platform 20 may also include: a ballast water system, which is fixedly connected to the floating body assembly 21. When the floating body assembly 21 is towed to the operating sea area and is not moored, the ballast water system may increase the load of the floating body assembly 21; when the floating body assembly 21 is moored to the operating sea area, the ballast water system may gradually reduce the load of the floating body assembly according to a preset increment.

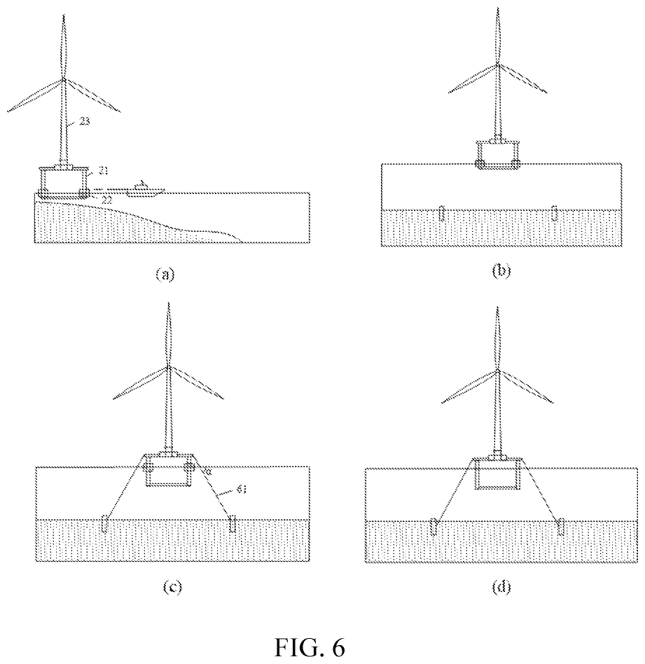

It can be understood that the ballast water system is fixedly configured on the floating body assembly 21. When the tension-leg floating offshore platform 20 is towed to the operating sea area, in order to enable the tension-leg floating offshore platform 20 to be connected to an anchor sunk at the bottom of the sea via a mooring rope 61 (as shown in (c) in FIG. 6), the ballast water system may increase the weight of the floating body assembly 21 by injecting ballast water, so that the floating body assembly 21 dives to the maximum draft. When the floating body assembly 21 has been moored to the operating sea area, the ballast water system may gradually reduce the load of the floating body assembly 21 according to a preset increment, so that the tension-leg floating offshore platform 20 gradually rises until the mooring rope 61 is in a tight state.

In an embodiment of the present disclosure, the anchor connected to the tension-leg floating offshore platform 20 via the mooring rope 61 may include but is not limited to: a gravity anchor, a pile anchor, a suction anchor, etc., which is not specifically limited in the embodiments of the present disclosure.

In an embodiment of the present disclosure, the ballast water system may be arranged on the interior of the floating body assembly 21 (not shown in the figures), such as the interior of the side column 211, the interior of the crossbeam 212, or the interior of the fixed floating body 213. The ballast water system may also be arranged at the bottom of the floating body assembly 21, i.e., the bottom of the fixed floating body 213. The location of the ballast water system is not specifically limited in the embodiments of the present disclosure.

In some possible implementations, during a process of the ballast water system increasing the load of the floating body assembly 21 to a first preset value, the temporary floating body 22 remains movably installed on the floating body assembly 21; after the ballast water system decreases the load of the floating body assembly 21 to a second preset value, the temporary floating body 22 is separated from the floating body assembly 21.

It can be understood that when the tension-leg floating offshore platform 20 is towed to the operating sea area, during the process of the ballast water system increasing the load of the floating body assembly 21 to the first preset value, the temporary floating body 22 remains installed on the floating body assembly 21. At the same time, due to the gradually increased load of the floating body assembly 21, the floating body assembly 21 dives gradually, and the temporary floating body 22 is not fixed with the floating body assembly 21 in the direction perpendicular to the sea surface, thus the temporary floating body 22 continues to maintain the original buoyancy, still remaining in a state of being partially above the sea surface; that is, the location of the temporary floating body 22 relative to the sea surface has not changed, while the floating body assembly 21 has dived partially relative to the sea surface. Therefore, the relative positional relationship between the temporary floating body 22 and the floating body assembly 21 is that the temporary floating body 22 moves upward by a certain distance relative to the floating body assembly 21. Where, the first preset value is the maximum load that the tension-leg floating offshore platform 20 can achieve when moored, and the second preset value is the critical value of the load when the temporary floating body 22 is separated from the side column 211, that is, after the load is increased to the first preset value, the load will no longer increase. After the tension-leg floating offshore platform 20 is connected to the anchor sunk at the bottom of the sea via the mooring rope 61, the load of the tension-leg floating offshore platform 20 is decreased, and will no longer continue to be reduced when it is reduced to the second preset value. At this time, the temporary floating body 22 is separated from the side column 211.

It should be noted that the first preset value and the second preset value may be designed according to actual needs, and the first preset value and the second preset value may be the same or different, which is not specifically limited in the embodiments of the present disclosure.

In an embodiment of the present disclosure, the load of the floating body assembly 21 may be changed by using the ballasting and de-ballasting functions of the ballast water system, without the need for complex equipment such as large construction ship and winch, which may save manpower and costs.

In some possible implementations, the tension-leg floating offshore platform 20 also includes: a mooring assembly 62 arranged on the floating body assembly 21. After the floating body assembly 21 is towed to the operating sea area, the mooring assembly 62 may be connected to the anchor sunk at the bottom of the sea so as to moor the floating body assembly 21 to the operating sea area. When the floating body assembly 21 is towed to the operating sea area, at least one portion of the floating body assembly 21 is located on a sea surface of the operating sea area, and the mooring assembly 62 is arranged on the at least one portion of the floating body assembly 21.

It can be understood that the mooring assembly 62 is used to moor the floating body assembly 21 on the operating sea area, and the location of the mooring assembly 62 on the floating body assembly 21 should be set at the portion of the floating body assembly 21 above the sea surface. For example, the mooring assembly 62 may be arranged on the crossbeam 212, when the floating body assembly 21 is located in the operating sea area, the crossbeam 212 is always above the sea surface, so that the mooring assembly 62 is also located above the sea surface.

In an embodiment of the present disclosure, the location of the mooring assembly 62 on the floating body assembly 21 should be set at the portion of the floating body assembly 21 above the sea surface, that is, the mooring assembly 62 is located at a higher position of the floating body assembly 21, which makes the floating body assembly 21 be suitable not only for deep water areas, but also for shallow water areas, such as a water depth above 40 m.

In some possible implementations, the crossbeams 212 are connected to a plurality of side columns 211, an end of the crossbeam 212 is exposed to the outer wall of the side column 211, and the end of the crossbeam 212 is configured to install the mooring assembly 62.

It can be understood that, as shown in FIG. 2, the end of the crossbeam 212 extends out of the side column 211 and extends outwardly. The mooring assembly 62 may be installed on the end of the crossbeam 212. In this way, after the mooring assembly 62 is connected to the anchor sunk at the bottom of the sea via a mooring rope 61, the mooring rope 61 does not scratch the side column 211, thereby reducing their wear and prolonging their service life.

In an embodiment of the present disclosure, the cross-sectional area of the crossbeam 212 is smaller than the cross-sectional area of the side column 211, and the end of the crossbeam 212 extends out of the side column 211 by about 5 m, which may effectively prevent the mooring rope 61 from scratching the floating body assembly 21.

In some possible implementations, the tension-leg floating offshore platform 20 may also include a wind turbine main body, which is arranged at the top center of the floating body assembly 21.

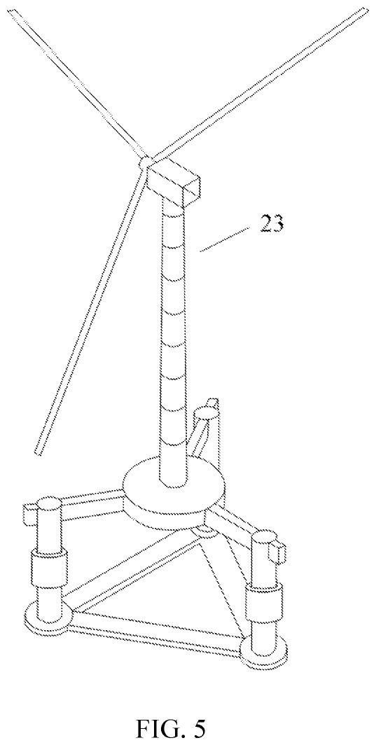

It can be understood that, FIG. 5 is another perspective view of a tension-leg floating offshore platform in an embodiment of the present disclosure. As shown in FIG. 5, the tension-leg floating offshore platform 20 may also include a wind turbine main body 23 in addition to the floating body assembly 21. The wind turbine main body 23 is arranged on a circular platform at the top center of the crossbeam 212 in the floating body assembly 21 and is connected to the floating body assembly 21 through the circular platform. The wind turbine main body 23 may generate electric energy through wind power and store the generated electric energy in an energy storage device, which is located inside the wind turbine main body 23 (not shown in the figure).

In an embodiment of the present disclosure, the wind turbine main body 23 may be a horizontal axis wind turbine or a vertical axis wind turbine, which is not specifically limited in the embodiments of the present disclosure.

In some possible implementations, the tension-leg floating offshore platform 20 may also include a data center, which is arranged inside the wind turbine main body 23.

It can be understood that, there is an empty cabin inside the bottom of the wind turbine main body 23, and the data center may be located in the empty cabin. The data center may include a plurality of data processing devices, and the plurality data processing devices may include: servers, data storage devices, network security devices, etc., which are not specifically limited in the embodiments of the present disclosure. The above-mentioned data processing devices consume a large amount of electric energy during operation process. At this time, the wind turbine main body 23 may provide power for the above-mentioned data processing devices. When the electric energy generated by the wind turbine main body 23 is greater than the electric energy consumed by the data center, the energy storage device may be configured to store this excess electric energy.

In an embodiment of the present disclosure, the tension-leg floating offshore platform includes a floating body assembly and a detachable temporary floating body. The detachable temporary floating body is not rigidly connected to the floating body assembly and may float up and down relative to the floating body assembly, making it easy to disassemble and install, and may be reused to reduce the cost of use.

In a second aspect, an installation method for a tension-leg floating offshore platform is provided in the embodiments of the present disclosure. FIG. 6 is a schematic flow chart of an installation method for a tension-leg floating offshore platform in an embodiment of the present disclosure. As shown in FIG. 6, the method includes: movably installing a temporary floating body 22 on a floating body assembly 21; controlling a ballast water system to increase the load of the floating body assembly 21 to a first preset value after the floating body assembly 21 is towed to the operating sea area; mounting an anchor on the floating body assembly 21 to moor the floating body assembly 21; controlling the ballast water system to gradually decrease the load of the floating body assembly 21 according to a preset increment; separating the temporary floating body 22 from the floating body assembly 21 after the load of the floating body assembly 21 is decreased to a second preset value.

It can be understood that, referring to (a) in FIG. 6, the tension-leg floating offshore platform 20 includes a floating body assembly 21, a temporary floating body 22 and a wind turbine main body 23, where the temporary floating body 22 is sleeved on the outer wall of the side column 211 in the floating body assembly 21. The tugboat tows the tension-leg floating offshore platform 20 away from the dock, enabling it to move in the seawater. At this time, the draft of the tension-leg floating offshore platform 20 is shallow, and the temporary floating body 22 is located at the bottom of the side column 211, which may provide a larger waterline surface and stability. Referring to (b) in FIG. 6, the tension-leg floating offshore platform 20 is towed to the operating sea area, and the bottom of the operating sea area is equipped with anchors that are placed in advance. At this time, the temporary floating body 22 is still located at the bottom of the side column 211. Referring to (c) in FIG. 6, the ballast water system in the floating body assembly 21 increases the load of the floating body assembly 21 to the first preset value by injecting the ballast water. While the load is increased, the floating body assembly 21 gradually dives to the preset location, the location of the temporary floating body 22 relative to the sea surface remains unchanged, and the temporary floating body 22 is always in a draught state, providing stabilizing support to the floating body assembly 21 so that the location of the tension-leg floating offshore platform 20 in a direction parallel to the sea surface remains unchanged. At this time, the anchor and the mooring assembly 62 on the floating body assembly 21 are connected together through the mooring rope 61. Referring to (d) in FIG. 6, after the tension-leg floating offshore platform 20 is moored to the operating sea area, the ballast water in the ballast water system is removed, so that the load of the floating body assembly 21 is decreased to the second preset value. At this time, since its buoyancy is greater than its gravity, the tension-leg floating offshore platform 20 gradually moves upward in a direction perpendicular to the sea surface, and the mooring rope 61 gradually becomes in a tight state until the tension-leg floating offshore platform 20 reaches the predetermined draft and pre-tension, and then the temporary floating body 22 is removed to complete the installation.

It should be noted that, the tension-leg floating offshore platform 20 mentioned in the above installation method is the tension-leg floating offshore platform 20 mentioned in the first aspect of the embodiments of the present disclosure. For the specific structure of the tension-leg floating offshore platform 20 is not described in detail here.

In an embodiment of the present disclosure, the mooring rope 61 may be one of the following: a steel wire rope, an anchor chain, and a fiber cable. The type of the mooring rope 61 is not limited in the embodiments of the present disclosure, which may be designed according to actual needs. When the mooring rope 61 is in a tight state, the mooring rope 61 has a small inclination angle α relative to the sea surface (referring to (c) in FIG. 6), and for example α is 15 degrees.

In an embodiment of the present disclosure, the temporary floating body may provide stability during the installation process of the tension-leg floating offshore platform and prevent the tension-leg floating offshore platform from overturning.

Those skilled in the art can understand that the magnitude of serial numbers of respective steps in the above embodiments does not imply the order of execution. The execution order of respective processes should be determined by their functions and internal logics, and should not constitute any limitation on the implementation process of the embodiments of the present disclosure.

The above embodiments are only used to illustrate the technical solutions of the present disclosure, but not to limit them. Although the present disclosure has been described in detail with reference to the aforementioned embodiments, it should be understood by persons skilled in the art that the technical solutions recorded in the aforementioned embodiments may still be modified or some of the technical features of the technical solutions may be equivalently substituted; while these modifications or substitutions do not make the essence of the corresponding technical solutions depart from the spirit and scope of the technical solutions of various embodiments of the present disclosure, and should be included in the protection scope of the present disclosure.

What is claimed is:

1. A tension-leg floating offshore platform, comprising: a floating body assembly and a detachable temporary floating body; wherein
during a process of the floating body assembly being towed to an operating sea area, the temporary floating body is movably installed on the floating body assembly;
after the floating body assembly is moored to the operating sea area, the temporary floating body is separated from the floating body assembly.

2. The tension-leg floating offshore platform according to claim 1, further comprising: a ballast water system fixedly connected to the floating body assembly; wherein
when the floating body assembly is towed to the operating sea area and is not moored, the ballast water system increases a load of the floating body assembly;
when the floating body assembly is moored to the operating sea area, the ballast water system gradually adjusts the load of the floating body assembly according to a preset increment.

3. The tension-leg floating offshore platform according to claim 2, wherein
during a process of the ballast water system increasing the load of the floating body assembly to a first preset value, the temporary floating body remains movably installed on the floating body assembly;
after the ballast water system decreases the load of the floating body assembly to a second preset value, the temporary floating body is separated from the floating body assembly.

4. The tension-leg floating offshore platform according to claim 1, further comprising: a mooring assembly arranged on the floating body assembly; wherein
after the floating body assembly is towed to the operating sea area, the the mooring assembly is able to be connected to an anchor sunk at a bottom of the sea so as to moor the floating body assembly to the operating sea area.

5. The tension-leg floating offshore platform according to claim 4, wherein when the floating body assembly is moored to the operating sea area, at least one portion of the floating body assembly is located on a sea surface of the operating sea area, and the mooring assembly is arranged on the at least one portion.

6. The tension-leg floating offshore platform according to claim 1, wherein the floating body assembly comprises: a fixed floating body, a crossbeam and a plurality of side columns; the fixed floating body and the crossbeam are arranged in parallel, and the plurality of side columns are vertically arranged between the fixed floating body and the crossbeam so as to connect the fixed floating body and the crossbeam; each side column is in a hollow structure; and the fixed floating body and the plurality of side columns are configured for providing buoyancy for the crossbeam.

7. The tension-leg floating offshore platform according to claim 6, wherein the temporary floating body is sleeved on the side column, and the temporary floating body is able to move relative to the side column.

8. The tension-leg floating offshore platform according to claim 6, wherein the crossbeam is connected to the plurality of side columns, an end of the crossbeam is exposed to an outer wall of the side column, and the end of the crossbeam is configured to install the mooring assembly.

9. An installation method for a tension-leg floating offshore platform, for installing the tension-leg floating offshore platform according to claim 1, comprising:
movably installing a temporary floating body on a floating body assembly;
separating the temporary floating body from the floating body assembly after the floating body assembly is moored to the operating sea area.

10. The installation method according to claim 9, further comprising: a ballast water system fixedly connected to the floating body assembly; wherein
when the floating body assembly is towed to the operating sea area and is not moored, the ballast water system increases a load of the floating body assembly;
when the floating body assembly is moored to the operating sea area, the ballast water system gradually adjusts the load of the floating body assembly according to a preset increment.

11. The installation method according to claim 10, wherein
during a process of the ballast water system increasing the load of the floating body assembly to a first preset value, the temporary floating body remains movably installed on the floating body assembly;
after the ballast water system decreases the load of the floating body assembly to a second preset value, the temporary floating body is separated from the floating body assembly.

12. The installation method according to claim 9, further comprising: a mooring assembly arranged on the floating body assembly; wherein
after the floating body assembly is towed to the operating sea area, the the mooring assembly is able to be connected to an anchor sunk at a bottom of the sea so as to moor the floating body assembly to the operating sea area.

13. The installation method according to claim 12, wherein when the floating body assembly is moored to the operating sea area, at least one portion of the floating body assembly is located on a sea surface of the operating sea area, and the mooring assembly is arranged on the at least one portion.

14. The installation method according to claim 9, wherein the floating body assembly comprises: a fixed floating body, a crossbeam and a plurality of side columns; the fixed floating body and the crossbeam are arranged in parallel, and the plurality of side columns are vertically arranged between the fixed floating body and the crossbeam so as to connect the fixed floating body and the crossbeam; each side column is in a hollow structure; and the fixed floating body and the plurality of side columns are configured for providing buoyancy for the crossbeam.

15. The installation method according to claim 9, wherein before the floating body assembly is moored to the operating sea area, the method further comprises:
controlling a ballast water system to increase a load of the floating body assembly to a first preset value after the floating body assembly is towed to the operating sea area;
mounting an anchor on the floating body assembly via a mooring rope to moor the floating body assembly;
controlling the ballast water system to gradually decrease the load of the floating body assembly according to a preset increment;
separating the temporary floating body from the floating body assembly after the load of the floating body assembly is decreased to a second preset value.
